(19) United States
(12) Patent Application Publication
(10) Pub. No.: US 2015/0108347 A1
(43) Pub. Date: Apr. 23, 2015

(54) METHOD AND APPARATUS TO DESOLVATE IONS AT HIGH PRESSURE AND TO IMPROVE TRANSMISSION AND CONTAMINATION IN THE COUPLING OF MASS SPECTROMETERS AND MOBILITY SPECTROMETERS WITH IONIZERS

(71) Applicant: Sociedad Europea de Analisis Diferencial de Movilidad, Madrid (ES)

(72) Inventor: Guillermo Vidal de Miguel, Zurich (CH)

(21) Appl. No.: 14/516,803

(22) Filed: Oct. 17, 2014

Related U.S. Application Data
(60) Provisional application No. 61/891,967, filed on Oct. 17, 2013.

(51) Int. Cl. H01J 49/04; G01N 27/62; H01J 49/16

(52) U.S. Cl. CPC H01J 49/044; H01J 49/165; G01N 27/622
USPC 250/288

(57) ABSTRACT

A method and apparatus that operate at near atmospheric pressure are described to simultaneously (i) desolvate the droplets produced by an ions source (including electrospray sources), to (ii) separate the surviving droplets from the analyte ions, to (iii) increase the transmission of ions through the inlet of an analyzer, while (iv) preventing the passage through said inlet of neutral contaminants and low mobility species and droplets that could potentially impair the operation of the analyzer, which include mass spectrometers and ion mobility spectrometers. In the present invention, contaminant low mobility species are efficiently deflected away from the analyzer inlet by a sweep flow. The sweep flow is laminar, affects ions in a region immediately after they leave the ionizer, and provides a preliminary separation of species. Consequently, the dilution effect produced by coulombic repulsion is minimized, and thus, analyte ions pass through the analyzer inlet with a higher transmission.

### CROSS-REFERENCE TO RELATED APPLICATION

This application claims the benefit of priority to U.S. Provisional Patent Application No. 61/891,967, filed on Oct. 17, 2013, the entire contents of which are incorporated by reference herein.

### FIELD OF THE INVENTION

The invention relates to an improved interface between an ionizer and an analyzer. More specifically, the invention teaches how to desolvate analyte ions at atmospheric pressure and to improve the transmission of analyte ions form the ionization source to the analyzer, while avoiding contamination produced by low mobility charged particles.

### BACKGROUND OF THE INVENTION

Electro-Spray Ionization (ESI) and Secondary Electro-Spray Ionization (SESI) are powerful tools, which are used for the ionization and further chemical analysis of complex samples from the liquid and the vapor phases, including the effluent of liquid cromatography, gas chromatography and electrophoresis separators. These ionization techniques typically operate at near atmospheric pressure, and they produce a rich variety of (i) analyte ions, (ii) charged droplets of the electrosprayed liquid, which contains the analytes, the solvents, and other contaminants, (iii) clusters, which might contain analytes, contaminants and solvent molecules, and (iv) vapors (for the clarity of the exposition, this mixture will be here referred to as the electrospray mist). However, very often only the analyte ions are of interest for the analytical applications.

Desolvation of Ions:

When coupled with mass spectrometers (MS), the electrospray mist must be dried prior to being analyzed, and the analyte ions must be separated from the rest of the contaminants so that their mass can be measured. Furthermore, it is important to reduce the content of condensable vapors when the mixture of charged particles is transferred from the atmospheric pressure side to the vacuum side of the mass spectrometer through the, so called, Atmospheric Pressure Interface (API). Otherwise, due to the rapid expansion of the supersonic jet, which drags the electrospray mist through the MS inlet (an orifice or a capillary), vapors would tend to condense on the majority of the ions, thus forming big droplets that would not be detected by the MS. Pneumatically assisted electrospray [See U.S. Pat. No. 4,861,988 A] improves the robustness of the ionization, but the increased liquid flow rates produce more and bigger droplets, which are more difficult to desolvate.

By means of an axial counterflow, Fenn and colleagues [U.S. Pat. No. 4,531,056] eliminate a sufficient amount of droplets and vapors prior to the inlet orifice of the MS, which enables a safe supersonic expansion, and a further mass analysis. However, ions are not completely dried by this counterflow feature. FIG. 1 illustrates schematically the axial counterflow configuration, which has two main problems: (i) due to the fact that the counterflow jet (1) impinges on the electrospray meniscus (2), the temperature of the counterflow jet is limited by the boiling point of the electrospray solvent; and (ii) the boundary layer (3) of the accelerating flow, and the shear layer (4) of the jet produce an inhomogeneous velocity profile (with lower velocities at the outer radius of the jet), through which charged droplets (5) can make their way against the counterflow and pass to the analyzer. Fortunately, once these charged droplets (5) reach the MS, at the low pressures produced downstream of the orifice inlet of the MS, the charged particles are accelerated by the local electric fields, and the collisions with the gas molecules are very energetic, thus facilitating de-clustering and evaporation. As a result, although the counterflow feature cannot totally dry the ions, the API also dries the droplets and clusters so as to produce pure ions, this besides separating neutral molecules and ions.

Also, the low pressures of the MS enhance diffusion, which facilitates evacuation of unwanted neutrals. As a result, due to the low pressure of operation of the MS, the API dries the analyte ions very efficiently. Indeed, other configurations do not use the counterflow feature described by Fenn. Instead, they heat the gas to prevent droplet condensation in the expanding jet. For instance, U.S. Pat. No. 4,977,320, U.S. Pat. No. 5,298,744, and U.S. Pat. No. 5,504,327 describe a heated capillary which heats the electrospray mist, evaporates the solvents, and passes the whole mixture to the low pressure side of the MS. In this region, the neutral species are pumped away in the subsequent pumping stages, and the ions are further dried by the heat of the charged particles, which is produced by means of electric fields, either by Direct Current (DC) potentials between electrodes or by the Radio frequency (RF) of quadrupoles, multipoles, and ion funnels used in the ion optics region. U.S. Pat. No. 5,756,994, U.S. Pat. No. 4,999,493 and U.S. Pat. No. 6,700,119 B1 describe an atmospheric pressure ionization interface for MS analysis in which the stream of gas and charged particles enter in a heated chamber, and where the path of the ions, as they pass though the subsequent pumping stages is angled so as to minimize the passage of droplets. These systems overcome the complications associated with the counterflow feature. However, drying the ions at low pressure has other drawbacks, high amounts of contaminants produced by the electrospray can enter the low pressure region of the MS, and these contaminants tend to deposits on the inner walls of the MS and the electrodes, which need to be cleaned. Cleaning the low pressure side of the MS becomes increasingly necessary if one needs to analyze complex samples incorporating low volatility species. And, because these parts are in the low pressure side of the MS, cleaning them is a time consuming operation, which typically requires stopping the vacuum system of the MS, filling the MS with high purity gas until it reaches atmospheric pressure, opening the MS, cleaning the parts which are contaminated, and re-starting the vacuum system (which might take up to one day or even one week, depending on the vacuum level required by each MS). Moreover, this operation must be performed carefully to avoid entrance of dust and other contaminants in the MS, which could impair its operation. As a result, the cleaning procedure, which would take only a few minutes if it was performed at atmospheric pressure, becomes a mayor maintenance operation.

Off-axis electrospray injection [See U.S. Pat. No. 5,750,988] also allows the quantity of ingested droplets to be reduced, but it does not eliminate completely the unwanted big droplets. U.S. Pat. No. 5,412,208 describes a configuration incorporating turbulent hot gas jets aiming at the electrospray plume upstream of the counterflow region. This configuration dries the droplets more quickly and, as a result, fewer droplets and more ions reach the counterflow region. However, the turbulent flow cannot improve the separation capacity of the counterflow, which inevitably passes clusters and traces of vapors to the downstream side of the orifice plate. The invention described in U.S. Pat. No. 7,145,136 B2 utilizes a modified counterflow configuration in which part of the counterflow gas is diverted towards the electrospray plume to enhance the drying process. Enhanced turbulent configurations are also used to promote droplet evaporation [See U.S. Pat. No. 6,700,119 B1 for instance].

In U.S. Pat. No. 7,534,997 B2, a flow of drying gas circulates between to plates, and the ion pathway, as defined by two orifices, has an offset that precludes the passage of big droplets, which follow a straight trajectory that would otherwise reach the orifice communicating with the MS. Smaller droplets reach the second orifice, but they travel a longer distance and are thus more desolvated. However, this system does not separate ions and droplets, likely because the flow is turbulent to enhance heat transfer to the droplets.

A system capable of completely drying the analyte ions at atmospheric pressure and of separating them from other vapors produced by the ionizer would eliminate the need to clean the low pressure side of the MS, and would thus greatly improve its robustness and maintenance costs. However, all the previous configurations described require the ions to be further dried in the low pressure region of the MS, which eventually gets contaminated. Consequently, one goal of the present invention is to provide a solution to the problem of desolvating the ions and separating them at atmospheric pressure (or at least above 100 Torr) from the droplets and vapors produced by the ionizer.

Ion Mobility Spectrometry (IMS) followed by MS analysis is an emerging and very powerful technique that provides extra structural information and separation capacity. According to their principle of operation, there are various IMS techniques, which will be all referred to as IMS in the context of this description. These techniques include Drift Tube IMS (DTIMS), Travelling Wave IMS (TWIMS), Field Asymmetric IMS (FAIMS), Differential Mobility Analysis (DMA), and Variable Electric Field Mobility Analysis (VEFMA). When the IMS is operated downstream of the API interface, it has the advantage that the ions previously pass through the API, and are thus well desolvated due to low pressures of operation of the API. However, these architectures have the disadvantage that the IMS cell needs to be integrated within the low pressure system of the MS, thus requiring a specific design. In contrast, IMS systems operating at higher pressures can operate upstream of the inlet of the MS, and can be developed independently. As a result, the IMS operating at atmospheric or near atmospheric pressures can be added to pre-existing mass spectrometers, as an add on gadget, which enables the user to independently choose the best MS and the IMS for each application, thus maximizing the flexibility of the IMS-MS system and the acquisition economical costs. Although these systems can be more cost effective, a new requirement arises: the analyte ions must be desolvated and separated from the other contaminants prior to their introduction in the IMS separation cell. DTIMS are used at atmospheric pressure in security applications in combination with radioactive ionization sources, which provide a particularly clean sample, which is free from solvents, and which is only useful for a limited family of species. However, these systems are not used with other ion source producing more complex samples because it cannot handle the vapors and incompletely desolvated samples produced by other ion sources.

Achieving a complete desolvation of analyte ions at atmospheric pressure is a complicated task for various reasons: (i) electrostatic ion heating is very low because, at atmospheric pressure, the mean free path of the ions (the averaged distance between collisions with other molecules of the gas) is very low, and hence the extra kinetic energy added by the electric fields onto the ion between collisions is very low; (ii) diffusion is low (in first approximation, it is inversely proportional to the pressure of the gas) and, as a result, vapors released by the droplets remain in the vicinity of the droplet, causing the local vapor pressure near the droplet to be very high. Moreover, due to the fact that ions are continuously colliding with molecules, the gas must be very pure because, otherwise, ions would collide with contaminants and could form new clusters even if one initially managed to completely dry the ions. To give an estimation of the required gas purity, an ion having a residence time of 1 ms in an IMS cell operated at atmospheric pressure will collide with a neutral molecule approximately 4·10⁶ times (every 0.2 ns in average), which means that it will very likely collide at least once with all contaminants present at a concentration in the order of one ppm. These collisions are not important if the contaminants do not react with the ions. However, if the contaminant forms a cluster with the ion, the mobility of the resulting charged particle will change in the middle of the analysis, leading to background signals, tails, and not well defined peaks in the mobility spectrum. Furthermore, if the presence of contaminants is not well controlled, they will lead to non repeatable results.

An attempt to dry ions at atmospheric pressure prior to IMS analysis is described in U.S. Pat. No. 7,351,960 B2. U.S. Pat. No. 7,351,960 B2 discloses a heated capillary, which situated between an ion source and the inlet of a FAIMS device, while this capillary can effectively desolvate droplets, the solvent vapors and the contamination produced during desolvation is conducted towards the FAIMS separation cell. Although ions can be desolvated in the capillary, they can be affected in the cell by the presence of said vapors within the FAIMS cell. As a result, the spectra produced by this system are subjected to poor resolving power and repeatability, and the peaks tend to produce long tails, which in turn lead to a high and undesired background signal level.

U.S. Pat. No. 7,005,633 B2 discloses a desolvation system comprising an axial counterflow which helps to dry droplets and which sweeps away the neutral molecules from the FAIMS device. U.S. Pat. No. 7,189,966 B2 describes an alternative axial counterflow configuration, which incorporates a porous diffuser to laminarize the flow fed to the counterflow chamber. Although these systems reduce the entrance of contamination in the separation cell, the axial counterflow configuration cannot efficiently remove charged droplets which have a sufficiently high mobility to travel against the counterflow current, and which tend to complete their drying process in the separation cell, thus releasing vapors in this region. As a result, although the concentration of contaminants is reduced, said concentration remains above the threshold required to operate the IMS system. This problem arises from the fact that the velocity profile of axial counterflow is not uniform, and partially clustered droplets can pass towards the analyzer through the regions of low velocity (such as the boundary layers, and recirculation regions). Also, the counterflow configuration tends to be turbulent, and some transient eddies can temporally facilitate the passage of droplets to the analyzer, which becomes contaminated for long periods of time.

In summary, regular counterflow is incapable of providing the required desolvation level, and no known desovation system is capable of (i) drying the analyte ions and (ii) eliminating the neutral vapor species as well as incompletely desolvated ions, such that ion mobility spectrometry systems (IMS), including DTIMS, TWIMS, FAIMS, DMA and VEFMA, can safely operate at atmospheric pressure with ion sources producing high amounts of solvents and contamination, such as ESI, nano-ESI, SESI, nebulizer assisted ESI, and other ion sources which can be easily identified by those skilled in the art. Consequently, another goal of the present invention is to provide a solution to the problem of desolvating the ions and separating them at atmospheric pressure from the droplets and vapors produced by the ionizer so as to allow the coupling of ionization systems with IMS systems operating at pressures close to the atmospheric pressure (or at least above 100 Torr).

Planar Differential Mobility Analyzer:

Planar Differential Mobility Analyzers (DMA) operated at high Reynolds Numbers and at near atmospheric pressure are used to select ions according to their mobility and, in tandem with a Mass Spectrometer (MS), they increase the overall selectivity of the compounded analyzer. In a DMA, a drifting gas flows between two parallel electrodes that produce a perpendicular electric field. Ions are driven by the fluid velocity in one direction and by the electric velocity, which is proportional to their mobility, in the perpendicular direction. All ions are introduced through an inlet slit (in the upper electrode), each following a different trajectory, and only ions having the selected mobility reach the outlet slit (in the lower electrode). J. Fernandez de la Mora and coworkers first introduced the use of planar DMA for tandem with MS in U.S. Pat. No. 5,869,831, where the planar DMA geometry allowed for very accessible inlet and outlets.

An improved configuration, taught by Rus et al. in U.S. Pat. No. 7,928,374, uses a specifically designed channel with an elongated shape in the DMA exit side that becomes round in the MS inlet side. Rus also teaches a specific mechanical design that precludes leaks that tend to arise in the geometry proposed in U.S. Pat. No. 5,869,831. He also teaches how to run the DMA drift flow in closed circuit with a gas tight pump so as to control the composition and purity of the gas utilized. Working in closed circuit is very important to reduce background contaminants naturally present in the ambient air, and also because the MS actually ingests part of the drift flow through said specific channel. Clean flow is inputted in the closed recirculation circuit to compensate for the flow ingested by the MS and also to produce a counterflow of gas through the inlet slit if the DMA that is required to ensure that the drift gas of the DMA remains clean when operating in closed recirculation circuit.

The advantages of planar DMA-MS over other IMS-MS configurations are: (i) compared to drift tube Ion Mobility Spectrometer (IMS) having typical duty cycles around 1%, the DMA can be tuned at a fixed mobility, allowing a continuous output of mobility selected ions; (ii) compared to cylindrical DMAs, the planar DMA outlet slit is very accessible, and coupling the DMA to an MS inlet is straightforward and allows high ionic transmission; and (iii) DMAs can handle relatively high ionic flow, which is directly related to the sensitivity.

The DMA transmission is mostly limited when ions pass through the DMA inlet slit. In the region downstream this slit, the electric field is produced by the voltage difference between the upper electrode and the lower electrode, and it effectively pushes the ions forward, but the upstream side of the DMA inlet slit is usually influenced by much lower electric fields. In the description of U.S. Pat. No. 7,928,374 an electrospray (ESI) is located in front of the inlet slit for the purposes of (i) generating the ions to be further analyzed, and (ii) generating the electric fields required to drive ions trough the DMA inlet slit. One first problem of this configuration is that the electric field generated by the electrospray near the DMA inlet slit is very low, and the resulting transmission is very poor. The problem of the configuration of U.S. Pat. No. 7,928,374 is even more pressing if the DMA is operated in closed circuit mode and if the specific ionization source also produces contaminants because then a counterflow has to be used exiting through the DMA inlet slit. This counterflow, as proposed in U.S. Pat. No. 7,928,374, is used to sweep away low mobility species and neutral species that, if entering in the closed DMA circuit, would contaminate it and impair its normal functioning.

A detail of the counterflow configuration of U.S. Pat. No. 7,928,374 is illustrated in FIGS. 2 and 3 with the streamlines and two types of trajectories including analyte ions (6) and low mobility charged droplets (5). This configuration has two main problems: (i) due to the fact that the counterflow (7) exits through the inlet slit of the DMA (8) with a very high tangential velocity acquired from the DMA drift flow (9), it forms a wall-jet (10) attached to the downstream side of the DMA upper electrode (11) that affects ions only in a very narrow region and, (ii) the boundary layer (3) of the flow causes the fluid velocity in the proximity of the upper edge (12) of the DMA inlet slit (8) to be very slow, thus allowing the passage of low mobility charged droplets (5) towards the DMA. FIG. 2 illustrates the inlet slit of DMA wherein, although the counterflow gas (7) efficiently sweeps away droplets (5) reaching the central region of the DMA inlet slit (8), the droplets (5) reaching the proximity of the upstream edge (12) of the inlet slit penetrate into the DMA recirculation circuit. In order to avoid transferring charged particles that could contaminate the DMA (i.e. droplets and partially desorbed clusters produced in the ESI) through the inlet slit, the electric field in the surroundings of the inlet slit should be very low. As a result, the transmission of the analyte ions (6) is very low. FIG. 3 illustrates the same configuration of FIG. 2, where the electric field is lower so as to avoid the penetration of droplets (5). Although droplets are eliminated, the flow of analyte ions (8) is also decreased substantially. In summary, the electric field in the upstream region of the inlet slit can be increased by means of extra electrodes, which increase the transmission. However, by increasing the electric field intensity passing through the inlet slit, some charged droplets and contaminants will eventually enter the DMA channel, thus contaminating it and leading to the problems caused by the formation of clusters (peak broadening and peak tails, which lead to undesired high backgrounds). In conclusion, it is not possible to selectively pass the analyte ions through the narrow inlet slit of the DMA with high ionic flow rates while at the same time avoiding the passage of partially declustered droplets and clusters, which tend to accumulate within the DMA drift flow channel, and which damages the quality of the mobility spectra. Accordingly, another objective of the present invention is to teach how to provide a flow of analyte ions sufficient to feed normal DMAs and mass spectrometers, which sample more than 0.25 lpm, wherein the droplets and other contaminants are eliminated down to a level compatible with the standards required by the DMA.

Vapor Ionization:

The analysis of species existing in a gas by virtue of their finite volatility is of interest in the resolution of many analytical problems. Ionizing the vapors directly at atmospheric pressure and then introducing the resulting ions into a mass spectrometer with an atmospheric pressure source (API-MS) is today the fastest approach for vapor analysis. This approach was pioneered by the TAGA system developed at Sciex [1], where vapor ionization was achieved by means of an electrical discharge. A significant advance towards the development of detectors for trace gases was taken in U.S. Pat. No. 4,531,056. The electrospray mass spectrometry method introduced by Fenn and Colleagues in U.S. Pat. No. 4,531,056 involves the use of a counterflow dry gas interposed between the atmospheric pressure inlet of the mass spectrometer and the electrospray source. The counterflow gas impinged frontally against the electrospray cloud, offering an excellent contacting area between the dry gas and the charged drops and electrospray ions. This useful feature was used in [2, 3] for volatile charging by feeding controlled quantities of vapor mixed with the counterflow gas. An important problem of this approach, when used for the analysis of ambient species, is that the sample ambient gas is generally not clean, whereby the analyzer would be rapidly contaminated. Independently, Wu et al. [4] also obtained similar results with an electrospray charger which they referred to as secondary electrospray ionization (SESI).

One solution to sidestep this contamination problem is proposed by Martinez-Lozano et al. [See US Patent Application Publication No. US 2010/0264304 A1], where the contaminated flow carrying the sample is fed through a secondary port into a chamber also enclosing the electrospray plume, and connected with the counterflow gas coming from the curtain plate orifice. This system contributed various improvements over prior art taught in [2, 3], whose combination enabled detection levels as small as 0.2 ppt for trace vapor species [5], while also moderating the ingestion of dust, water vapor and other contaminants into the mass spectrometer. Briefly, the vapors to be analyzed are ionized by contact with a source of charge, and then the ionized vapors are transferred to the analyzer by the electric field produced by the electrospray, while the majority of neutral vapors are swept away by the counterflow gas.

However, this configuration is not very efficient. In order to facilitate ionization of the sample and the ingestion of the resulting sample ions into the analyzer, the sample gas and the ionizing agents emitted by the electrospray must coexist in a volume (termed ionization volume) where the ions thus formed can reach the entrance of the analyzer. In order for the sample gas to be ionized, it must reach the ionization volume, but the ionization volume tends to be substantially occupied by the clean counterflow gas. The sample flow can reach the ionization volume either weakly by diffusion across the counterflow jet, or more vigorously by having sufficient momentum to deflect the counterflow jet away from part of the effective ionization volume. In this configuration, the electrospray tip must be maintained at a certain distance from the curtain plate orifice, such that the counterflow jet is sufficiently weakened to be deflected. But this also weakens the electric fields produced by the electrospray, and the ionic flow rate quickly decreases. Experimental results show that, at a tradeoff distance of around 2 cm between the electrospray and the curtain gas plate, this configuration produces the best results. Furthermore, the unbounded lateral impaction between the counterflow jet and the sample flow is typically unstable and leads to mixing and dilution. To counteract dilution, and to partially deflect the counterflow jet away from the ionization volume, the sample flow rate clearly needs to be higher than the counterflow. But such high sample flow rate implies a very low ionization efficiency (defined as the ratio of sample ions produced to sample molecule introduced).

A solution to sidestep this dilution problem, termed Low Flow SESI, is taught in U.S. Pat. No. 8,217,342 B2 and U.S. Pat. No. 8,461,523 B2, where sample dilution and loss of useful ionization volume associated with the counterflow jet are virtually eliminated by performing the functions of the ionizer and the counterflow gas in two different regions. The approach is particularly advantageous in situations where the available vapor sample is limited. The ionizer isolates the ionization region from the counterflow region by placing them in separate chambers: an ionization chamber and a clean gas chamber. The sample flow enters the ionization chamber where it is mixed with the electrospray plume, producing SESI sample ions at a uniform concentration resulting from the equilibrium between the counterbalancing effects of (i) the chemical reaction by which charging ions transfer their charge to the sample species, and (ii) the coulombic repulsion that dilutes the newly formed ions [6-8]. Electric fields drive the sample ions through the impaction orifice communicating the ionization chamber with the clean gas chamber. Sample flow is also accelerated through the impaction orifice and forms a jet that precludes counterflow clean gas from entering the ionization chamber. Penetration of the counterflow gas into the ionization region and dilution of the sample are averted by using a sufficiently small impaction orifice. Once in the clean gas chamber, ions are pushed towards the analyzer by the electric fields, while the counterflow jet emerging from the curtain plate orifice minimizes the passage of vapors towards the analyzer. Finally, ions along with clean gas are sampled by the analyzer. As shown in FIG. 4, the counterflow gas (1) impacts with the sample jet (13) near the impaction orifice (14) (hence its name), where it is deflected and evacuated along with the majority of big droplets and contaminating vapors. The desired ion flux is driven by the electric fields, and is therefore relatively independent of the sample flow (15) rate which can be reduced to low values. In short, a high conversion of vapor molecules into ions feeding the analyzer is achieved by combining this high ionic flow to sample flow ratio with a relatively high sample ion concentration obtained by keeping the disruptive effects of the counterflow gas (1) away from the ionization chamber (16). The method taught in U.S. Pat. No. 8,217,342 B2 and U.S. Pat. No. 8,461,523 B2 could ideally achieve ionization efficiencies approaching 100%, but it requires a very careful design. Of special importance for the purposes of the present invention are the designs of the impaction region (17) and the clean counterflow region (18).

The fluid flow in the impaction region (17) needs to be stable to avoid convective penetration of counterflow gas (1) into the ionization chamber (16). From this perspective, the impaction orifice (14) should be as small as possible. But it should not be made too small. The sample ions (19) have to be extracted from the ionization chamber (16) by the electric field. Using very intense electric fields and a very thin impaction plate (20) to allow passage of the electric streamlines allows the required ionic flow rate to be produced, while minimizing the diameter of the impaction orifice (14). A jet of sample flow (13) is used to sweep those instabilities away from the ionization region, and thus the minimum sample flow that the ionizer can work with is limited by those instabilities in this region. Real samples are often collected in traps or cloths and then vaporized for further analysis, and introducing these off-line samples often requires opening and closing the leak-tight sample flow circuit whose pressure is above the atmospheric pressure because of the pressure drop along the outlet tubes used to evacuate the sample and the counterflow gas. This pressure difference initiates transient pressure variation within the ionizer when an off-line sample is introduced, that induce uncontrolled variations in the flows that perturb the delicate fluid flow configuration required in the impaction region. This effect can be reduced by pumping out the outlet (counterflow plus sample) flow by means of a downstream pump that reduces the pressure of the ionizer until it equals the atmospheric pressure, but the pump still produces instabilities that, after traveling upstream, also affect the impaction region stability. As a consequence, a minimum sample flow is necessary to sweep those instabilities, therefore limiting the ionization efficiency that can be achieved.

As discussed in U.S. Pat. No. 8,217,342 B2 and U.S. Pat. No. 8,461,523 B2, no new sample ions (19) can be produced in the clean region (18) downstream the impaction region because it is free from vapors, but space charge, basically produced by the concentration of the charging agents (21), still tends to dilute ions. In order to minimize dilution of sample ions in this region, passage of ions through this region should be made as fast as possible, and this is achieved by means of intense electric fields and very short paths. But these intense electric fields also force low mobility particles (5), such as charger droplets (produced for instance if the charging agent is an electrospray) to travel against the counterflow gas, thus introducing big contaminants into the analyzer. As a result, the ionizer of U.S. Pat. No. 8,217,342 B2 and U.S. Pat. No. 8,461,523 B2 is subjected to an inconvenient tradeoff between transmission of sample ions and transmission of contaminants which can be specially harmful if the ionizer is coupled with an IMS operating at atmospheric pressure (or at pressures higher than 100 Torr). Consequently, one objective of the invention is to teach how to desolvate the analyte ions and to separate the sample ions from other contaminants, including partially desolvated charged droplets and big clusters, prior to their analysis by and analytical instrument, where said ions are produced by means of a Low Flow SESI ionizer, as described in U.S. Pat. No. 8,217,342 B2 and U.S. Pat. No. 8,461,523 B2.

Coupling the Planar DMA with the Low Flow SESI Vapor Ionizer:

The problem of contaminating the DMA is even more significant if the source of ions is a Low Flow SESI as taught in U.S. Pat. No. 8,217,342 B2 and U.S. Pat. No. 8,461,523 B2. Real word analysis requires a tradeoff between sensitivity and selectivity. The Low Flow SESI increases sensitivity, and thus it also increases the number of species that produce detectable signals. A Low Flow SESI in combination with a Planar DMA in tandem with a MS (including also MS-MS) also increases the capacity of the analyzer to differentiate species (compared to MS alone). Coupling the Low Flow SESI with a Planar DMA is proposed in U.S. Pat. No. 8,217,342 B2 and U.S. Pat. No. 8,461,523 B2. According to it, this can be achieved simply by putting the Impaction slit facing the DMA inlet slit such that ions exiting the impaction slit are guided by means of electric fields toward the DMA, the scheme is illustrated in FIG. 5. However, this direct coupling suffers from three main problems:
(i) Sample ions are diluted in the space between the impaction slit of the LFSESI and the inlet slit of the DMA by the coulombic repulsion produced by the charging agents, though the effect is minimized by using intense electric fields and very short distances between the impaction slit and the DMA inlet slit (the clean region).
(ii) The counterflow gas emerges through the DMA inlet slit in the shape of an attached wall jet, and its velocity in the direction opposed to electric field is very week. As a consequence, the intense electric field required in the clean region to minimize space charge dilution also drives low mobility contaminants, such as big droplets produced by the electrospray, towards the recirculation circuit of the DMA. These low mobility contaminants, mainly composed of electrospray solvent droplets, are accumulated in the recirculation circuit, and the vapor pressure of the solvents rises within it in an uncontrolled fashion. Because the mobility of the ions can be highly affected by the presence of volatilized polar solvents [9] (typically used in electrospray solutions), producing undesired peak shifts, peak broadening and peak tails, the DMA behavior becomes unpredictable and unreliable.
(iii) Because the DMA along with the pump and the recirculation circuit constitute a relevant volume of some liters, the transient flows produced when working in off-line mode tend to be also strong, even if the pressure is further stabilized by means of a controlled suction pump located at the system outlet because the pump itself still produces instabilities difficult to control.

The transmission through the inlet of DMAs, including planar DMA, operated with a counterflow of gas exiting through the inlet slit is poor because the counterflow forms a lateral wall jet that diverts low mobility charged particles and neutral species that could contaminate the DMA very inefficiently and, as a consequence, the electric fields near the inlet slit have to be weakened so as to avoid forcing contaminating particles trough the inlet slit. As a result, the transmission of the ions of interest is also weakened and, if one decided to increase deliberately the electric field intensity near the DMA inlet slit, as proposed in the coupling a Low Flow SESI with the DMA, low mobility contaminants would inevitably by entered in the DMA drift flow. Consequently, another purpose of the present invention is to teach how to prevent contamination of the DMA due to charged particles and neutral species produced in the ionization source, while increasing transmission through the inlet slit of the DMA. Another purpose of the present invention is to teach how to optimize the interface of the DMA with a vapor ionizer; and more particularly, other purposes of the present invention are to teach:
(i) how to prevent contamination of the DMA due to charged particles and neutral species produced in the ionizer while increasing transmission through the inlet slit of the DMA,
(ii) how to separate charging agents from sample ions immediately downstream the impaction region in order to avoid the pernicious coulombic repulsion produced by the highly concentrated charging agents, and
(iii) how to stabilize the pressure of the system for off-lime mode of operation. And more specifically, the new invention teaches how to prevent contamination of the DMA due to charged particles and neutral species produced when the ionizer is a Low Flow SESI vapor ionizer.

### SUMMARY OF THE INVENTION

A method and an apparatus are described to desolvate ions at near atmospheric pressure, and to transmit the analyte ions from an ionization source to an analyzer, said ionization source producing charged particles of interest, charged droplets, and other low mobility charged particles and neutral species that could contaminate the analyzer if introduced in it. The new invention uses a High pressure Desolvation Sweep Flow (HPD Sweep Flow) that is provided by means of a clean gas source. The HPD Sweep Flow passes through a heating stage, a laminarizing stage, optionally, an acceleration stage, and it finally passes through a channel defined between a pair of electrodes that separate the ionizer from the analyzer, and which are respectively named HPD inlet electrode and HPD outlet electrode. Charged particles and other neutral species produced in the ionization source are introduced trough a slit defined through said HPD inlet electrode. Once in the High pressure Desolvation channel, droplets are subjected to a high temperature gas, the temperature of which is higher than the boiling point of the liquid forming said droplets. This temperature is not limited by the stability of the ion source because the HPD sweep flow does not impinge on the ion source. As a result, higher temperatures can be achieved and droplet evaporation is faster than it would be if the drying gas was aimed directly towards the source of ions. Moreover, said HPD sweep flow, in combination with the electric field produced between said HPD inlet and outlet electrodes, push the analyte ions such that they follow an oblique trajectory and reach the outlet slit of the HPD, while said low mobility charged particles and neutral species, which could otherwise contaminate the analyzer, are swept away by the sweeping flow, thus preventing them from reaching the analyzer inlet. Because, in the new configuration, the neutral gas does not obstruct the passage of said analyte ions, and also because the HPD sweep flow sweeps low mobility particles very efficiently starting at the very moment they leave the impaction slit, the electric fields within the desolvation and separation region can be augmented such that the flow of said analyte ions through said analyzer inlet slit is maximized, while contaminating species are not allowed to pass through an inlet of an associated analyzer.

### BRIEF DESCRIPTION OF THE DRAWINGS

FIG. 1 (Prior Art) illustrates schematically the axial counterflow configuration.

FIG. 2 (Prior Art) illustrates schematically the counterflow configuration of the DMA, where the electric field in the region of the DMA inlet slit is strong.

FIG. 3 (Prior Art) illustrates schematically the counterflow configuration of the DMA, where the electric field in the region of the DMA inlet slit is weak.

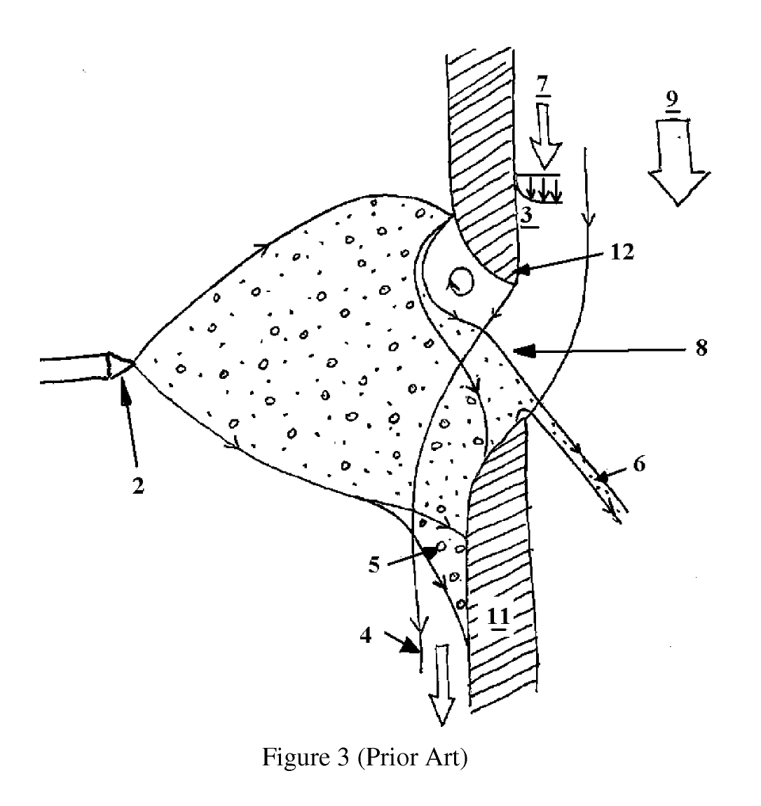

FIG. 4 (Prior Art) illustrates schematically the Low Flow SESI, in combination with an axial counterflow.

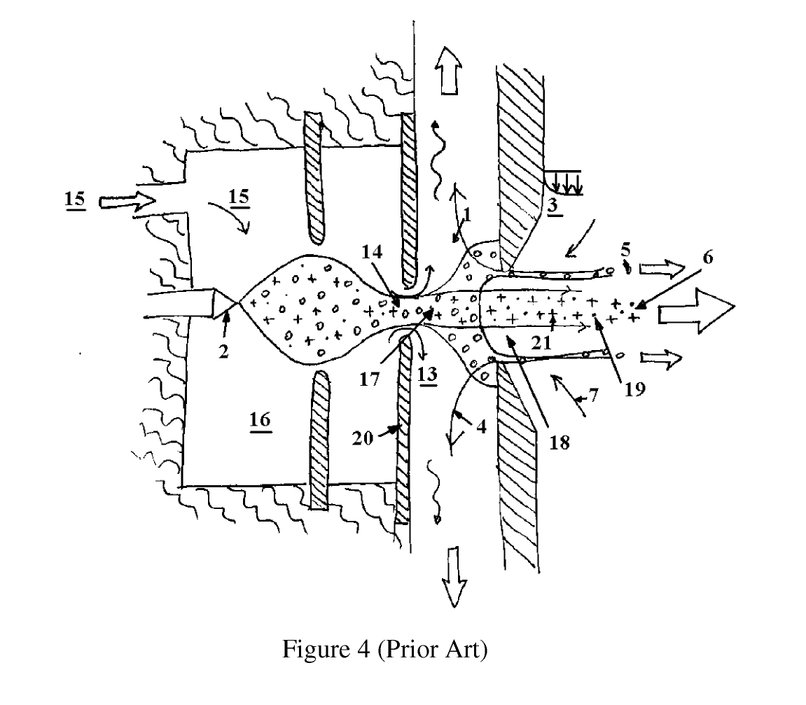

FIG. 5 (Prior Art) illustrates schematically the Low Flow SESI, in combination with a DMA inlet and a wall jet counterflow.

FIG. 6 illustrates schematically the new High pressure Desolvation system of the present invention.

FIG. 7 illustrates schematically the new High pressure Desolvation system of the present invention, further incorporating an axial counterflow stage to further dry ions.

FIG. 8 illustrates schematically the new High pressure Desolvation system of the present invention, further coupled with a DMA.

FIG. 9 illustrates schematically the new High pressure Desolvation system of the present invention, further coupled with a Low Flow SESI.

FIG. 10 illustrates schematically the new High pressure Desolvation system of the present invention, further coupled with a Low Flow SESI and a DMA.

FIG. 11 illustrates schematically a detail of the different streamlines of the different species of the new High pressure Desolvation system of the present invention coupled with a Low Flow SESI and a DMA.

FIG. 12 illustrates schematically the new High Pressure Desolvation System of the present invention, further incorporating a recirculating circuit and a pump-less system to accelerate the sweep flow.

### DETAILED DESCRIPTION OF THE INVENTION

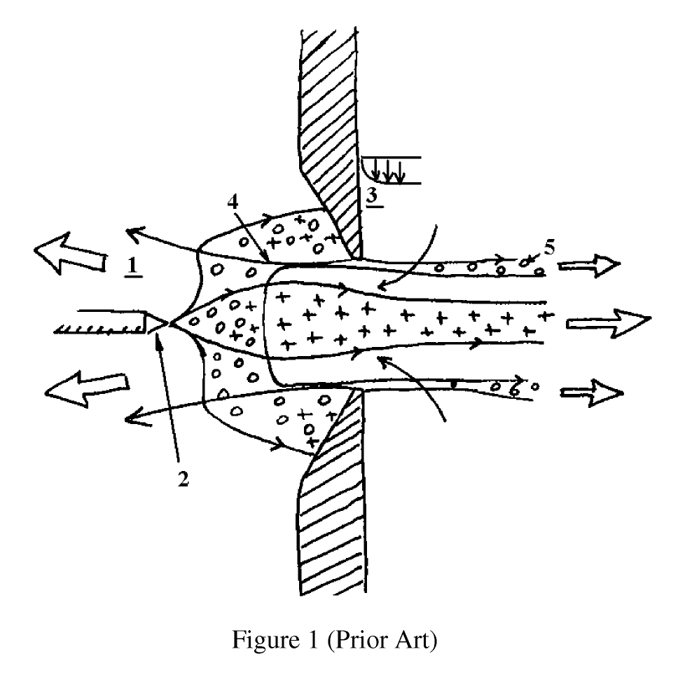

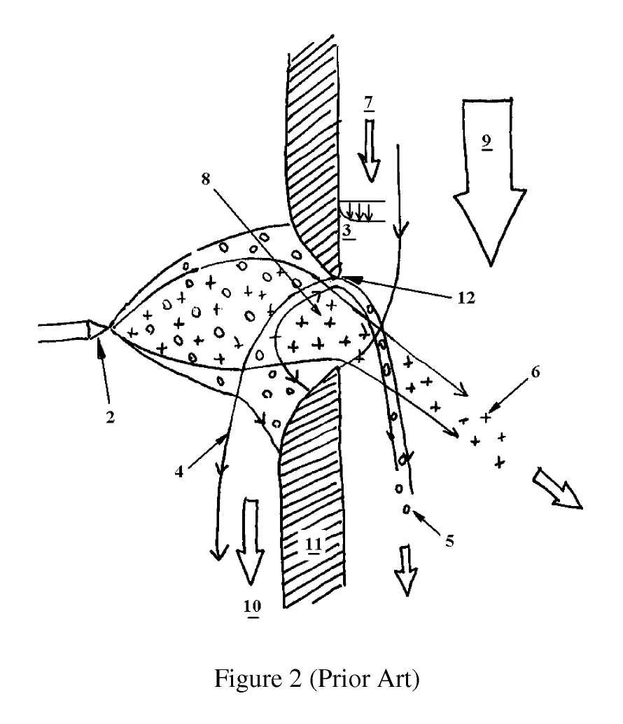

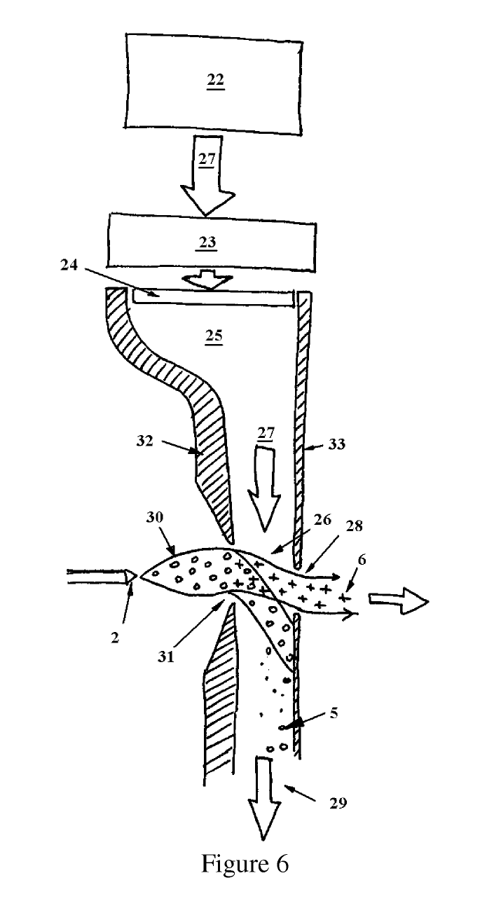

In one embodiment of the present invention, a flow of laminar and high temperature gas (termed HPD sweep flow) evaporates a fraction of the droplets and sweeps the surviving droplets laterally, as illustrated in FIG. 6. This configuration, termed High Pressure Desolvation (HPD), comprises a source of clean gas (22), a heating stage (23), used to heat the gas to a uniform and high temperature, a laminarizing stage (24), optionally, an acceleration stage (25), a desolvation and separation region (26) through which the HPD sweep flow (27) circulates, and in which electric field pushes the analyte ions (6) towards an HPD outlet slit (28), and a HPD sweep gas outlet (29). The electrospray mist (30) is imputed through a HPD inlet slit (31), once in the the HPD desolvation and separation region (26), which is formed between an inlet HPD electrode (32) and an outlet HPD electrode (33), droplets (5) are heated by the gas, which flows at a temperature higher than the boiling temperature of the solvent, and they are quickly evaporated. At the same time, the different particles of the electrospray mist (30) are separated according to their mobility. Desolvated ions evaporated from the droplets move towards the HPD outlet slit (28), while droplets (5) are swept downstream by the HPD seep flow (27). In contrast with the configurations depicted in FIGS. 1 and 2 (axial counterflow, and wall jet counterflow), all particles transferred must cross the central part of the HPD desolvation and separation region (26), where the velocities of the flow are high. As a result, there are no regions though which low mobility droplets can be transferred (i.e. boundary layers, and the like). The new configuration also allows the HPD sweep flow to be at temperatures that may be well above the boiling point of the electrospray solvent (including 10° C., 20° C., 50° C. and 100° C. above the electrospray solvent boiling point), while the electrospray can be maintained at a lower temperature to prevent the electrospray meniscus from boiling. As a result, the process of droplet evaporation and ion declustering may be enhanced. Moreover, the laminar flow allows for the separation of analyte ions (6) and droplets (5), which follow steady and different paths (note that separation can only be accomplished with laminar flows, which require a careful aerodynamic design). As a result, analyte ions (6) and droplets (5) are separated (which is one of the purposes of the present invention) as they enter the desolvation and separation region (26), and the space charge repulsion and dilution effects are reduced, thus increasing the transmission of analyte ions (6). The different ions (including analyte ions and high mobility small ions) may be also pre-separated in the HPD desolvation and separation region (26). Although the separation capacity provided by the HPD is usually low, it is nevertheless sufficient to allow different ions to travel through differentiated streamlines. The HPD separates the analyte ions from low mobility droplets, and it also separates the analyte ions from high mobility small ions, which would otherwise dilute the analyte ions by space charge effects, and which cannot be eliminated by means of an axial counterflow due to their high mobility. As a result, the HPD reduces the space charge repulsion and dilution of the analyte ions more efficiently than the regular axial counterflow.

The HPD can be operated in an open circuit, where the gas is directly provided by means of a clean gas generator or a clean gas container (including gas cylinders and other suitable containers), and it can also be re-circulated in order to obtain higher flows, which provide a better separation capacity. In contrast with conventional planar DMAs, the HPD performs the tasks of separating droplets and ions, and desolvating ions in one single stage (while the DMA is designed only to separate ions according to their mobility). In order to achieve the extra task of drying the droplets and desolvating the ions, the HPD operates at much higher temperatures, and it is able to ingest the complete electrospray mist, which cannot be handled by the DMA because vapors would tend to accumulate within the recirculation circuit. This it does at the cost of a lower resolving power by operating with lower flow rates, which enables renewing a higher fraction of the HPD sweep flow (at least 10% or 20% or 50% or 100%) so as to maintain a higher standard of purity even when the HPD is ingesting the complete electrospray mist. Also, the HPD sweep flow utilized allows for; heating the gas with moderate power input (lower than 5 kW) prior to its entrance into the HPD desolvation and separation region, and/or cooling the gas downstream the desolvation and separation region by means of a passive radiator or a heat exchanger—hence eliminating the complications associated with operating the pumps at high temperature (either by eliminating the requirement of a pump or by enabling the pump to be operated at moderated temperatures while operating the HPD at high temperatures).

The HPD can be coupled with an MS. In such a case, it is preferable to shape the outlet slit of the HPD so that the side facing the HPD desolvation and separation region has the shape of an elongated slit, while the side facing the MS inlet is a round orifice.

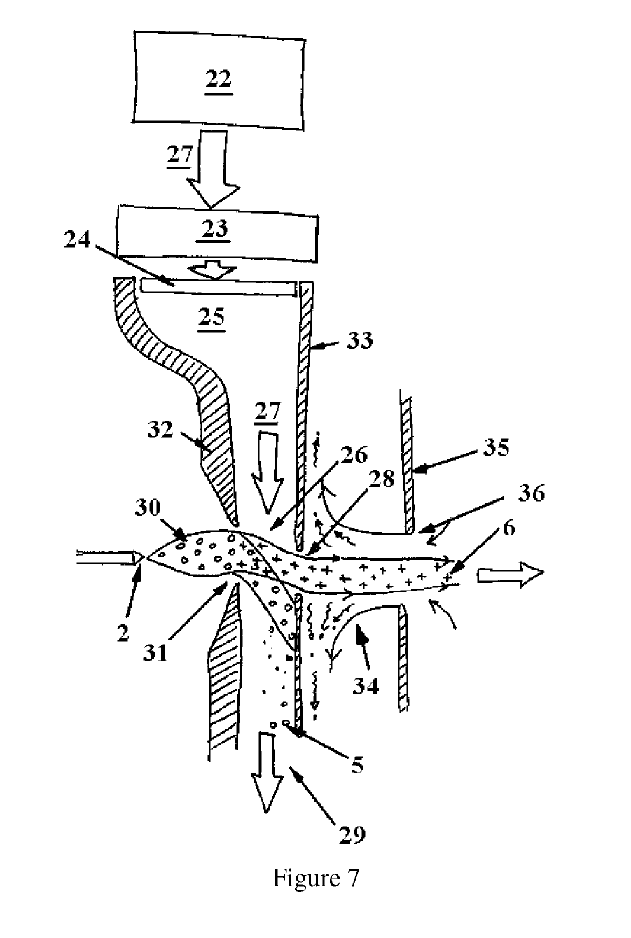

In another embodiment of the present invention, and with reference to FIG. 7, the HPD further incorporates an axial counterflow region (34) downstream the HPD outlet slit (28), in which ions are further declustered. In a regular axial counterflow configuration, due to the fact that all species travel together, the coulombic repulsion within the ion beam is very strong, and hence the time of residence of the ions through the gas is limited by space charge. In contrast, in the new configuration, ions (including analyte ions and high mobility small ions) and droplets are pre-separated in the HPD desolvation and separation region (26), and only the analyte ions reach the new axial counterflow region (34), where space charge repulsion is thus minimized. The electric field within the axial counterflow region is provided by an axial electrode (35), and it can be selected so as to maximize the time of residence of the ions within this new axial counterflow region (34), though without negative consequences from the transmission viewpoint. As a result, ions have more time to get desolvated, and space charge losses are minimized. FIG. 7 illustrates a HPD further incorporating an axial counterflow region and an axial electrode. The HPD sweep flow is provided by means of a source of clean gas (22), which can be a clean gas generator, which might reutilize the gas outputted though the HPD sweep gas outlet. The clean gas (27) is passed to a heating stage (23), where it is heated to a uniform temperature, which can be selected so as to desolvate the particular analyte ions to be analyzed. Once heated, the gas passes through a laminarizing stage (24), where the flow is forced to pass through a set of meshes of a material capable of operation at high temperatures (such as PEEK or fiber glass, or other materials known to those skilled in the art), which eliminate turbulence. An acceleration region (25) may be provided after the laminarizing stage which accelerates the hot and laminar HPD sweep flow (27) towards the desolvation and separation region (26). Finally, the HPD sweep flow is evacuated through the HPD sweep gas outlet (29). The desolvation and separation region is bound by two electrodes, which incorporate an HPD inlet slit (31), and an HPD outlet slit (28), and which are shaped to produce an electric field which pushes the ions from the HPD inlet slit (31) towards the HPD outlet slit (28), to allow the passage of the HPD sweep flow (27) between them, and to maintain a laminar and steady flow. These electrodes are also heated in order to maintain the HPD sweep flow at the required high and uniform temperature. In one embodiment of the present invention, the HPD outlet slit further communicates with a region where a stream of axial counterflow gas, which emerges from an axial orifice or slit (36) through the axial electrode (35), and which flows towards the HPD outlet slit, further helps to dry the analyte ions (6). A potential is applied to said axial electrode (35) so as to produce an electric field that pushes the analyte ions (6) from the HPD outlet slit towards the axial slit or orifice (36). The gas within said axial counterflow region is also heated, and ions can undergo complete declustering prior to being analyzed with minor losses produced by space charge. A fraction of said stream of axial counterflow gas can pass through the HPD outlet slit (28) so as to minimize the passage of the HPD sweep flow (27) towards the region where said stream of axial counterflow flows. The axial electrode (35) and the outlet HPD electrode (33) may be separated by means of an insulator (not shown), which can also incorporate an outlet and a valve to control and to optimize the fraction of said stream of axial counterflow which is outputted through the HPD outlet slit (28) and the fraction of gas outputted through the outlet in the space between the axial electrode (35) and the outlet HPD electrode (33).

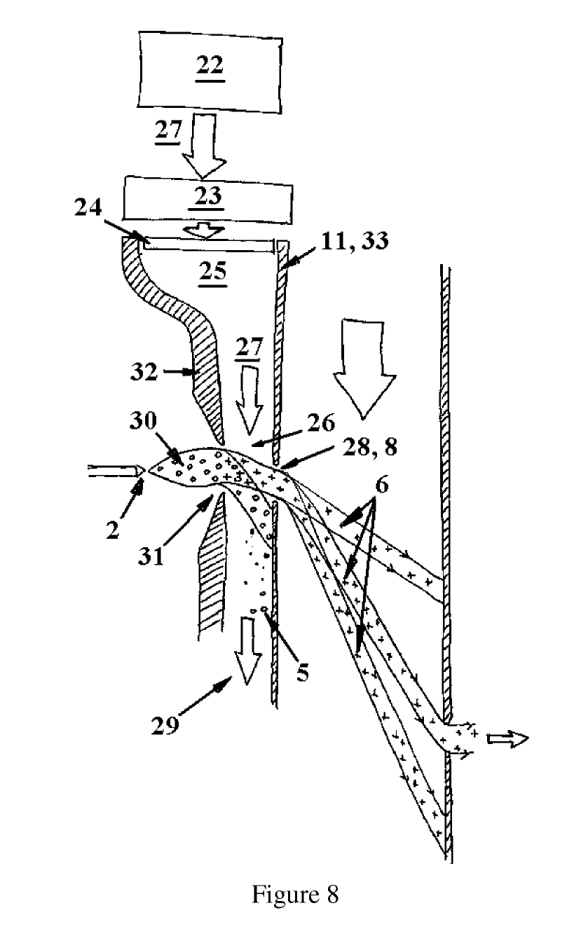

FIG. 8 illustrates another embodiment of the present invention, where the HPD is coupled with the Planar DMA taught in U.S. Pat. No. 7,928,374, the contents of which are incorporated herein by reference. The HPD prevents vapors and charged droplets from entering through the DMA inlet slit, while it allows the passage of analyte ions (6). This new invention allows the DMA to be operated at moderate temperatures, and maintains the high purity of the DMA recirculation circuit, which is required to prevent clustering, declustering, and tale formation within the DMA channel. As a result, the DMA in conjunction with the HPD enable cleaner and more repeatable spectra. In this embodiment of the present invention, the HPD sweep flow (27) is provided by means of a source of clean gas (22), heated by a heating stage (23), the turbulence is eliminated in a laminarizing stage (24), and the hot and laminar HPD sweep flow is accelerated through an acceleration stage (25) formed between an HPD inlet electrode (32) and the DMA inlet electrode (11), which acts at the same time as the HPD outlet electrode (33), and which is accordingly designed to allow a smooth non-detached and laminar flow of the HPD sweep flow (27). As will be appreciated by those skilled in the art, the HPD outlet electrode may both define the outlet of the HPD and the inlet an associated analyzer, such as a DMA or other analytical instrument or analyzer discussed herein. The two elements may be provided separately as well. Finally, the HPD sweep flow passes through the desolvation and separation region (26), and then it is evacuated through the HPD sweep gas outlet (29). The electrospray mist (30) enters the HPD through the HPD inlet slit (31), droplets (5) are dried within the desolvation and separation region (26), and only the dried analyte ions (6) reach the HPD outlet slit (28), which acts also as the inlet slit of the DMA (8). For this slit to efficiently transfer the dried analyte ions (6) from the HPD to the DMA, and to maintain a laminar flow both in the HPD acceleration and desolvation region (26) and in the DMA drift flow (9), the electrode (11, 33) separating the two channels must be very thin, and the edges of the slit must be sharp and aligned with the flows (which locally circulate in parallel). Note here that the HPD separates ions from droplets, and big clusters, and that one of its main features is being capable of receiving an electrospray mist (30) (including droplets), and passing only the ions. However, the HPD cannot separate different ions according to their mobility because it does not provide a good resolving power. In contrast, the DMA alone separates different ions with much better resolving power, but it cannot receive droplets because the vapors thus released would impair its performance. Combined together, the HPD and DMA provide an analyzing tool capable of (i) receiving an electrospray mist, such as those produced by ESI, nebulizer assisted ESI, LC columns followed by ESI and other ionizers producing ions as well as droplets, which are well known for those skilled in the art, (ii) drying some of said droplets so as to produce a mixture of dried analyte ions and to transfer said mixture through the inlet of a DMA, (iii) separating said mixture of dried analyte ions and (iv) providing a continuous output of mobility selected ions through the outlet of the DMA. In another embodiment of the invention, the HPD may be coupled with the Variable Electric Field Mobility Analyzer (VEFMA) of U.S. Pat. No. 8,378,297 B2. In this case, the HPD outlet slit serves as the inlet slit of the VEFMA. In the present invention, a flow of gas emerges from the VEFMA chamber to the HPS sweep flow channel through the slit communicating both regions so as to prevent the passage of high speed gas into the VEFMA, which would produce a turbulent configuration within the VEFMA chamber. A similar approach applies to other IMS that require a continuous input of ions at its inlet, including FAIMS.

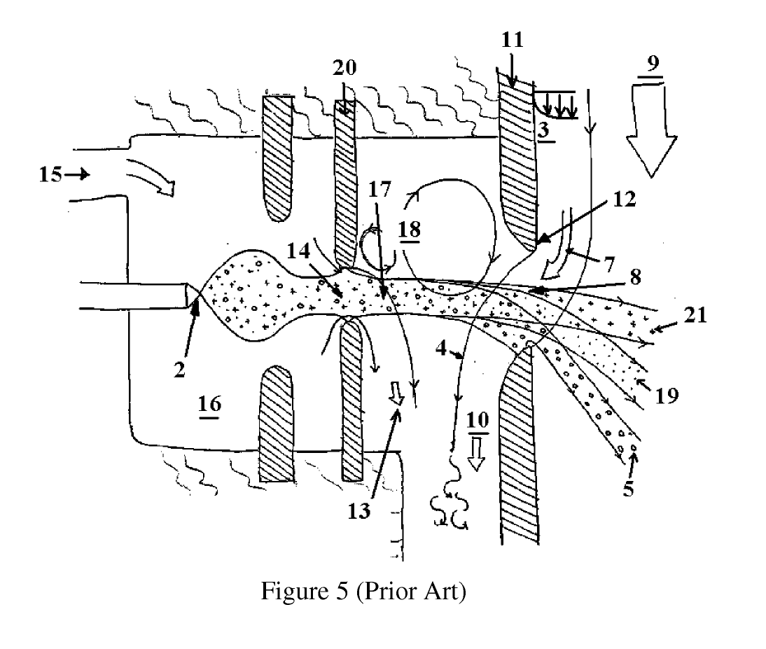

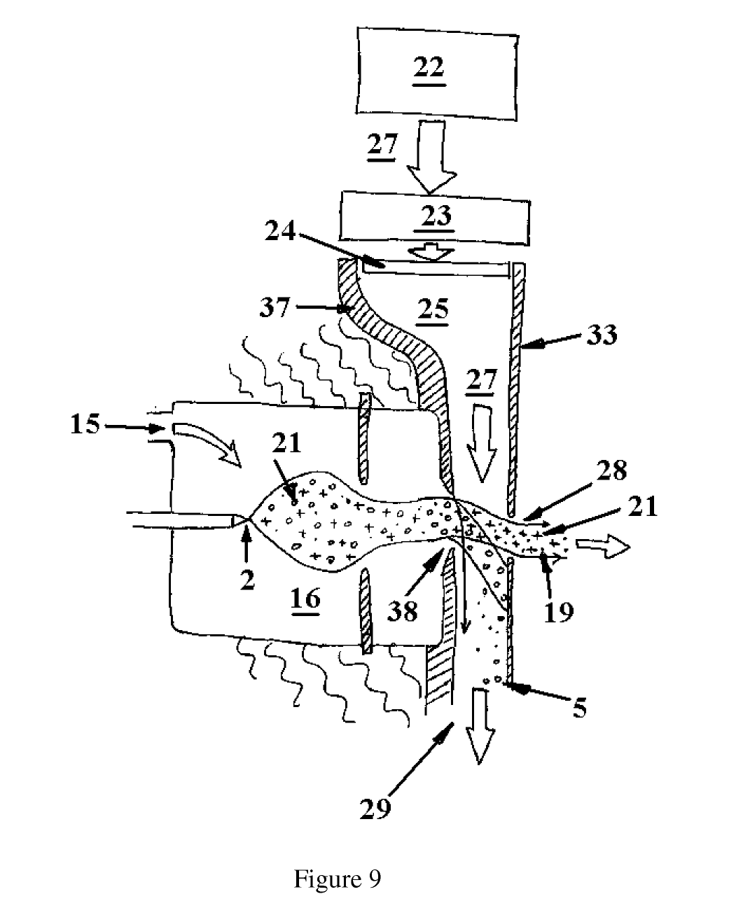

In another embodiment of the present invention, as shown in FIG. 9, the HPD herein disclosed is used in combination with the Low Flow SESI (LFSESI) of U.S. Pat. No. 8,217,342 B2 and U.S. Pat. No. 8,461,523 B2. As explained in U.S. Pat. No. 8,217,342 B2 and U.S. Pat. No. 8,461,523 B2, in the LFSESI shown in FIG. 5, charging agents (21) react with neutral vapors to produce sample ions (19) in an ionization chamber (16), in which the electric fields push the ions toward an impaction plate (20) having an impaction orifice or slit (14). In the region downstream said impaction plate (20), the charging agents (21) (including ions and droplets (5) produced by the electrospray) travel together with the sample ions (19) against an axial counterflow jet (1), which is meant to reduce the content of droplets (5) ingested by the analyzer, and which also prevents vapors (including sample vapors) from entering the analyzer (i.e. a MS or an IMS). One main problem of this configuration is that sample ions are quickly diluted due to the effect of the strong coulombic repulsion produced by the charging ions (21) in this region.

FIG. 9 illustrates the improved LFSESI, which incorporates an HPD downstream the impaction plate (20) according to the present invention. A source of clean gas (22) produces a continuous flow of gas, which passes through a heating stage (23), which heats the gas to the preferred temperature (usually above the boiling point of the electrospray solvent), the hot gas is then passed through a laminarizing stage (23) to eliminate turbulent velocity components, and the clean, heated, and laminar flow is optionally accelerated through an acceleration stage (25) formed between the impaction plate (20) of the LFSESI, which now acts also as the HPD inlet electrode (32), and which is now termed HPD impaction plate (37), and an HPD outlet electrode (33), which incorporates a HPD outlet slit (28) that communicates directly with the analyzer inlet. Finally, the HPD sweep flow (27) exits through an outlet. In order to maintain a laminar flow, the shapes of the HPD impaction plate (37) and said HPD outlet electrode (33) must be carefully designed to maintain a streamlined shape and to avoid detachment of the boundary layer. The sample flow (15) exits through the HPD impaction slit (38) so as to prevent HPD sweep flow (27) from entering in the ionization chamber (16), and it is further dragged downstream. Sample ions (19), and charging agents (21) also pass through the HPD impaction slit (38) under the influence of the local electric fields. A voltage is applied at the HPD impaction plate (37) and, as a result, ions are accelerated from the HPD impaction slit (38) towards the HPD outlet slit (28). Once in the desolvation and separation region (26), the different species are roughly separated according to their mobility. Although the separation capacity of the HPD is poor if compared with that of the DMA, it is sufficient to reduce dilution of the sample ions (19) due to the space charge repulsion produced by the charging agents (21). Finally, the sample ions are delivered to the analyzer through the HPD outlet slit (28), which communicates with the analyzer.

Another embodiment of the new invention utilizes the High Pressure Desolvation described in the present description, an ionizer, which can be the Low Flow SESI taught in U.S. Pat. No. 8,217,342 B2 and U.S. Pat. No. 8,461,523 B2, among others, and the Planar DMA taught in U.S. Pat. No. 7,928,374, the contents of which are incorporated herein by reference, and further provides a HPD sweep gas (27) flowing in the space between the impaction plate (HPD impaction plate) and the upper electrode of the DMA, this space termed now the sweeping channel.

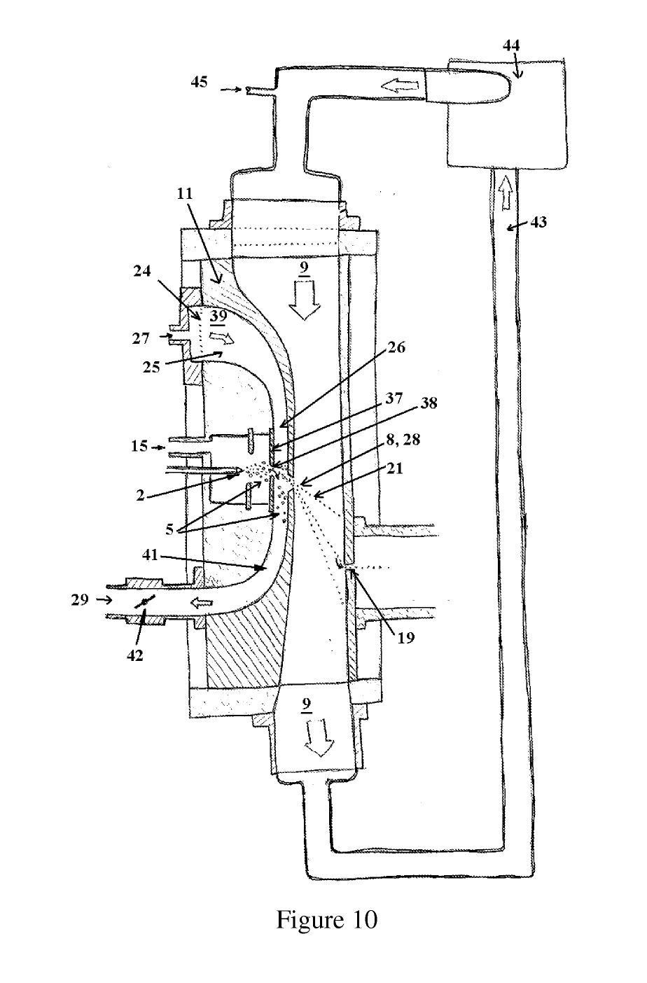

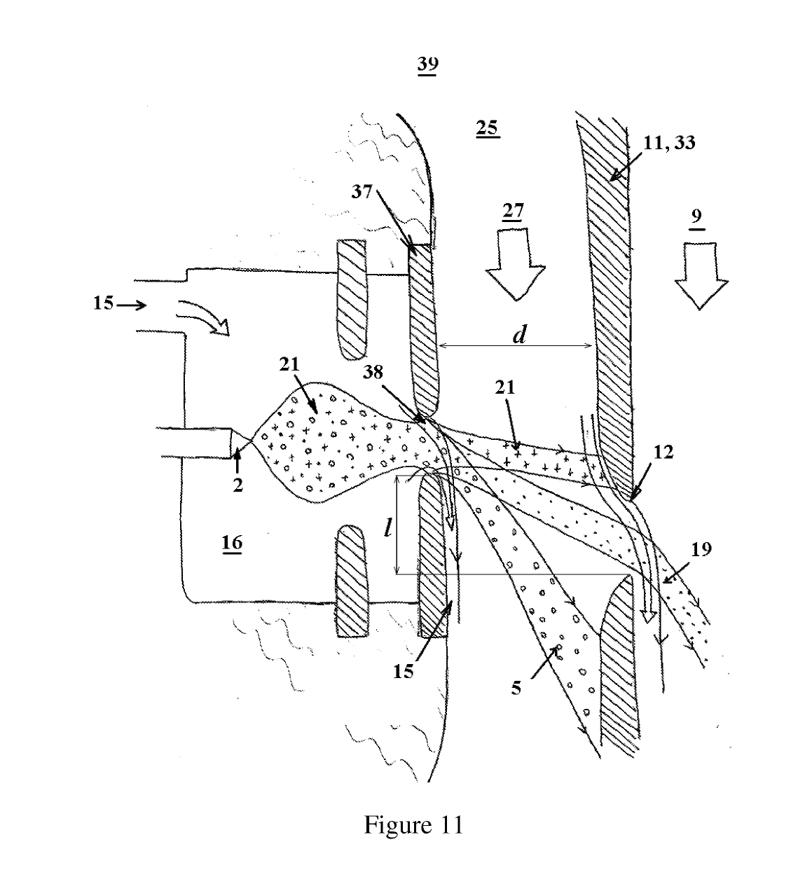

FIGS. 10 and 11 illustrate schematically the improved interface including the sweeping channel (39). The HPD sweep flow (27) flows perpendicularly to the electric field formed between the HPD impaction plate (37) and the upper electrode (11) of the DMA, and thus trajectories of the ions emerging from the HPD impaction slit (38) are separated according to their mobility much as in the DMA. There is a geometrical offset between the HPD impaction slit (38) and the DMA inlet slit (8) (l) such that the desired ions reach the DMA inlet slit. The HPD sweep flow (27) drags low mobility particles and big droplets (5) that could contaminate the DMA away from the DMA inlet slit, thus preventing them from entering in the DMA channel (40). Another advantage of the HPD sweep flow is that it separates the trajectories of the sample ions (19) and those of the charging agents (21) immediately after ions cross the HPD impaction slit (38) and leave the ionization region. Consequently, sample ions cross the sweeping flow region alone, and coulombic dilution associated to space charge repulsion produced by the charging agents (21) is minimized. FIG. 11 shows schematically the gas streamlines and the trajectories followed by the different charged species in the new desolvation and separation region (26), where droplets (5) and charging agents (21) are separated from the sample ions (19) that now travel free from space charge dilution immediately after they cross the HPD impaction slit (38).

In order to take full advantage of the Low flow SESI, the sample flow (15) has to be as low as possible, and the passage of the HPD sweep flow (27) through the HPD impaction slit (38) has to be avoided. This is achieved by passing the HPD sweep flow through a laminarizing stage (24) right after it is heated in a heating stage (23), and, optionally, accelerating the HPD sweep flow though a smooth geometry so as to minimize turbulence (termed the acceleration stage (25)), and by passing the sample flow (15) through the HPD impaction slit (38). Laminarization meshes can be used in the laminarizing stage to minimize turbulence.

The HPD sweep flow outlet (29) is highly contaminated because it receives the big droplets, and the sample gas. And thus the gas exiting through the outlet of the sweeping flow channel is usually evacuated and cannot be reused, in contrast with the drift flow of the DMA, which is usually recirculated. Nevertheless, in an embodiment of the invention, this gas can be cleaned and reutilized. In one embodiment of the invention, the HPD sweep flow (27) is continuously provided by a source of clean gas (22). Examples of clean gas sources include cylinders, dewars, nitrogen and/or air purifiers and generators, as well as other sources, all included in the present invention, that can be easily identified by those skilled in the art.

The gas is re-circulated in the DMA by means of a re-circulation circuit (43) and a re-circulation pump (44) because the high resolution requires high Reynolds Numbers, and thus it also requires very high flow rates. To give an idea, the planar DMA described in in U.S. Pat. No. 7,928,374 achieves a resolution of almost 80 using a drift flow of approximately 1000 lpm. Purifying the required flow rate in an open loop circuit would be prohibitive. For this reason, an extra inlet (45) is provided to at least renew the re-circulating flow by inputting a flow equivalent to the flow outputted through the DMA inlet and outlet slits, which is much lower than the DMA drift flow (9). In contrast, for the purpose of the present invention, the sweeping channel (39) does not require a high resolution, it only needs to separate big droplets from the ions of interest. In general, there are two main factors limiting the resolution of DMAs: (i) the resolution limit produced by diffusion that scales with the square-root of the applied voltage; and (ii) resolution limit produced by the ratio of the drift flow (or the sweeping flow in our case) to the flow of ions, which scales with the drift flow. By using a high voltage within the sweeping channel (39), diffusion effects are minimized. A sweeping flow of 10 lpm can be easily handled by commercial and portable gas purifiers, and it produces a resolution nearing 2, which is limited by the ratio of the drift flow (or the HPD sweep flow in our case) to the flow of ions. This low resolution is very poor for a DMA, but it is enough to ensure that the HPD separates analyte ions from contaminants and droplets. Advantageously, the relatively low sweeping flow required implies also much lower Reynolds Number configurations that tend to be less turbulent. Moreover, because diffusional effects are minimized, and also because a relatively wide flow of ions is produced (hence the relatively low resolving power of the configuration), the transmission of the ions of interest through the sweeping channel (39) can easily approach 100%.

By introducing the clean HPD sweep flow, the gas reaching the DMA inlet slit is clean, and thus counterflow through this slit is no longer required. More advantageously, part of the HPD sweep flow can be introduced through the DMA inlet slit to facilitate passage of ions through said slit and improve transmission. By operating the DMA in closed circuit and by not adding any extra gas to the re-circulation circuit, the flow ingested by the MS automatically drives the required flow through the DMA inlet slit, such that a perfect match between the two slits (DMA inlet and outlet) is accomplished.

An optional diffuser (41) located in the sweeping channel (39) downstream the impaction and the DMA inlet slits can be used for pressure recovery. The overall pressure drop from the HPD impaction slit (38) to the outlet of the sweeping channel (39), that includes the pressure drop through the ducts and the pressure recovery in the diffuser, can be balanced by means of a valve (42) so as to maintain the HPD impaction slit (38) at atmospheric pressure. This feature allows for minimizing transient pressure evolutions produced when working in off-line mode without the need of a suctioning pump. This pressure regulation system is much more stable than the suctioning pump, and improves the stability of the delicate impaction region, thus enabling the ionizer to work more efficiently with lower sample flows.

The DMA voltage and the voltage applied to the HPD impaction plate (here termed HPD Voltage) can be controlled independently to ensure that the bands of mobilities transferred by the two filters are coincident. Usually, since the band of mobilities passed through the HPD desolvation and separation region is much wider than that of the DMA, the HPD voltage can simply be left at a constant value, and only change the voltage of the DMA. However, in order to ensure that ions go over exactly the same trajectory when they are selected, the HPD Voltage can be varied proportionally with the DMA voltage. Finally, to ensure that ions behave similarly in both the DMA and in the sweeping flow channel, the electric intensity field and the temperature can be tuned similar in both filters.

Providing similar temperatures can be accomplished by two alternative ways, both included in the present invention: (i) the temperature of the sweeping flow can be homogenized by thermally isolating all the channel walls except the wall that is in contact with the upper electrode of the DMA such that heat is transferred from the DMA gas to the sweeping flow by conduction trough the upper electrode until the equilibrium is reached; (ii) the temperature can also be controlled independently in the DMA re-circulating circuit and in the HPD sweep flow by using one or more external active heater(s), preferably also measuring the temperatures and controlling said heaters by a closed loop control scheme, such as a Proportional Integral Derivative controller.

Providing similar electric fields in the DMA and in the HPD requires a more careful design of the interface. One would first think that providing similar electric fields is as easy as providing the right voltages, but we also need to do it in such a way that ions are transferred simultaneously through the HPD and through the DMA, and this mode of operation requires a more refined design. Provided that the DMA fluid speed is optimized and fixed, and that its internal geometry is also fixed, the electric component of the velocity (V_{E}) of the selected ions is also fixed. With reference to FIG. 11, the desolvation and separation region may be characterized by the distance (d) between the HPD impaction plate and the upper electrode of the DMA, and the longitudinal geometrical offset (l) between the HPD impaction slit and the DMA inlet slit. Provided that the electric component of the velocity of the ions has to be fixed (it has to be equal to that of the DMA), and that the sweeping flow (q) is also fixed because it will be typically limited by the capacity of the clean gas source, the value l must satisfy: 1=q/V_{E}, where q is in m²/s, (or, more intuitively, in liters per minute and unit of slit length). To give an example, for V_{E}=25 m/s, and q=12 lpm/4 mm=0.041 m²/s (which is the equivalent to 12 lpm HPD sweep flow passing through a desolvation and separation region with an HPD inlet slit of 4 mm long), the geometrical offset has to be l=2 mm, and the Reynolds of the sweeping flow is Re=q/v (where v=1.5.10⁻⁵ m²/s is the cinematic viscosity of the gas), Re=2700. This resulting Re is above the critical Re, and shows that a careful design will be required to prevent the turbulent transition, but it is still a moderate value (critical Re ranges from 2300 to 2500, depending on the configuration) and thus a smooth and converging geometry can easily maintain an attached and laminar flow. The description of this embodiment of the invention is based on the specific case including Low Flow SESI ionizer, but other types of ionizers different from the Low Flow SESI, including, but not limiting to ESI, nanosprays, pneumatically assisted electrosprays, can also be coupled with the invention to improve sensitivity and to avoid contamination by using the interface of the present invention.

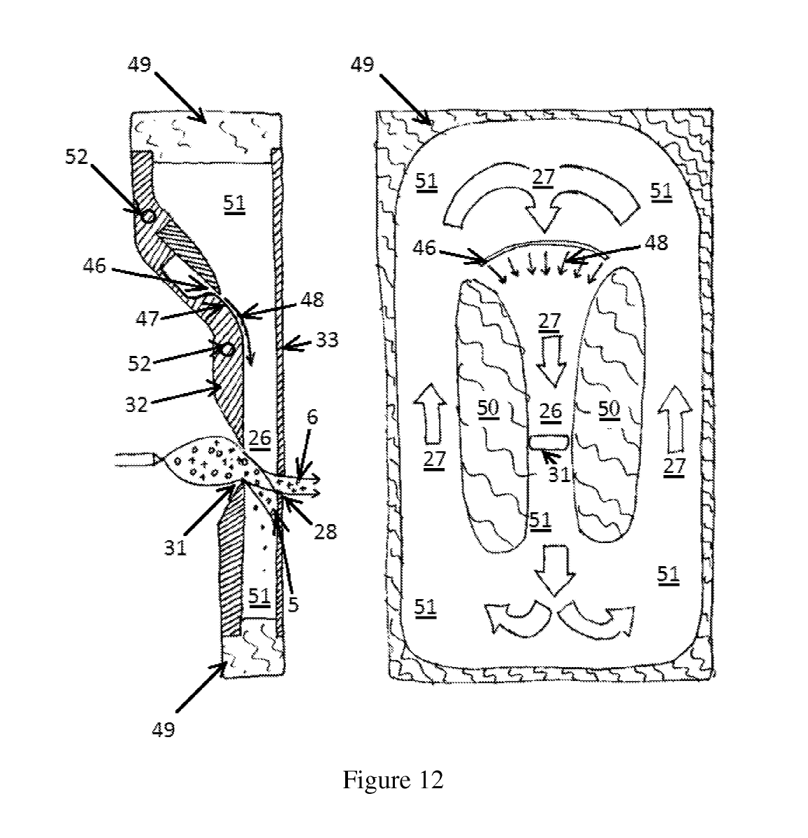

Recirculating the sweep flow with a pump limits the maximum temperature of the flow because some parts of the pump, or even the lubricants of the motor, release vapors and aerosol particles that ca bind with the ions, thus hindering desolvation. In order to recirculate the flow, a stream of high velocity gas is inputted in the recirculating circuit, as illustrated in FIG. 12. The high velocity gas enters in the recirculating circuit, and exchanges momentum with the gas that recirculates within the recirculating circuit, which gains momentum as a result of the exchange. As a result, the sweep flow that circulates through the HPD is much higher than the flow of high velocity gas consumed by the system, which must be provided from a source of clean gas. This new configuration has two main advantages: (i) As it has no moving parts, the associated complexity is avoided, (ii) as a result of its simplicity, the system is particularly robust against corrosive solvents. For the same reason (iii) it can operate in a wide range of temperatures.

In a preferred embodiment of the present invention, and with reference to FIG. 12, a high velocity flow is injected through a slit (46) that forms a wall jet (47) upstream of a Coanda expansion (48), which creates a pressure drop that accelerates a the sweep flow (27) through a channel formed between the HPD inlet electrode (32) and the HPD outlet electrode (33). These two electrodes, together with an insulator box (49) and two insulator separators (50), form a channel that bounds the desolvation and separation region (26), and also a recirculating circuit (51). The voltages applied to the electrodes push the ions from the HPD inlet slit (31) towards the outlet (28). The majority of the flow is pumped by the stream of high velocity gas, and it is also recirculated in said recirculating circuit (51) so as to reduce energy losses. As a result, a high flow of pure gas is recirculated with only a low consumption of gas. These electrodes also incorporate resistive heaters (52) to heat them so as to ensure that the recirculating gas remains at the desired temperature. The ions and droplets enter this desolvation and separation region (26) through a slit (31) in the inlet electrode (32), which communicates with the ionizer (ESI or other). The droplets (5) are evaporated and swept away by the sweep flow (27), and only the analyte ions (6), pushed by the electric field, reach the outlet slit (28) which communicates with the analyzer inlet. This system allows to separate the ions of interest from other contaminants, including droplet. It also serves to separate the analytes of interest from other buffer ions. This system is also useful to desolvate ions prior to their analysis in the IMS analyzers, but it could easily be useful as a stand-alone pre-cleaning stage directly coupled with API-MS, since it reduces contamination of the vacuum interface, and thus enhances its robustness and enable increasing the flow sampled by the MS.

### U.S. PATENTS AND APPLICATIONS CITED

U.S. Pat. No. 4,861,988 A; U.S. Pat. No. 4,531,056; U.S. Pat. No. 4,977,320; U.S. Pat. No. 5,298,744; U.S. Pat. No. 5,504,327; U.S. Pat. No. 5,756,994; U.S. Pat. No. 4,999,493; U.S. Pat. No. 6,700,119 B1; U.S. Pat. No. 5,750,988; U.S. Pat. No. 5,412,208; U.S. Pat. No. 7,145,136 B2; U.S. Pat. No. 7,534,997 B2; U.S. Pat. No. 7,351,960 B2; U.S. Pat. No. 7,005,633 B2; U.S. Pat. No. 7,189,966; U.S. Pat. No. 5,869,831; U.S. Pat. No. 7,928,374; US Patent Application Publication No. US 2010/0264304 A1; U.S. Pat. No. 8,217,342 B2; U.S. Pat. No. 8,461,523 B2; U.S. Pat. No. 8,378,297 B2.

### OTHER DOCUMENTS CITED

[1] Lane, D. A.; Thomson, B. A. Monitoring a chlorine spill from a train derailment. J. Air Pollution Control Assoc. 1981, 31 (2), 122-127
[2] Whitehouse, C. M., Levin, F., Meng, C. K. and Fenn, J. B., Proc. 34th ASMS Conf. on Mass Spectrom. and Allied Topics, Denver, 1986, p. 507.
[3] Fuerstenau, S., Kiselev, P. and Fenn, J. B., ESIMS in the Analysis of Trace Species in Gases. Proceedings of the 47th ASMS Conference on Mass Spectrometry (1999) Dallas Tex.
[4] Wu, C., Siems, W. F. and Hill, H. H. Jr., Secondary Electrospray Ionization Ion Mobility Spectrometry/Mass Spectrometry of Illicit Drugs. Anal. Chem. 2000, 72, 396-403).
[5] P. Martinez-Lozano, J. Rus, G. Fernández de la Mora, M. Hernández, J. Fernández de la Mora, Detection of explosive vapors below part per trillion concentrations with Electrospray charging and atmospheric pressure ionization mass spectrometry (API-MS). J. Am. Soc. Mass Spectr. doi:10.1016/j.jasms0.2008.10.006.
[6] Martinez-Lozano Sinues P., Criado E. and Vidal G.; Mechanistic study on the ionization of trace gases by an electrospray plume; International Journal of Mass Spectrometry (2011)
[7] Vidal-de-Miguel G., Herrero A.; Secondary Electro Spray Ionization of complex vapor mixtures. Theoretical and experimental approach; Journal of the American Society for Mass Spectrometry (2012)
[8] Fernandez de la Mora J.; Ionization of vapor molecules by an electrospray cloud; International Journal of Mass Spectrometry, 300 (2011) 182-193.
[9] Bradley B. Schneider, Thomas R. Covey, Stephen L. Coy, Evgeny V. Krylov and Erkinjon G. Nazarov; Chemical Effects in the Separation Process of a Differential Mobility/Mass

What is claimed:

1. A system to minimize contamination resulting from a flow of ions transmitted from an ionization source to an analyzer, said ionization source producing charged particles of interest and other low mobility charged particles, including charged droplets, and neutral species within the flow of ions that could contaminate the analyzer if introduced therein, the system comprising:
an inlet electrode and an outlet electrode spaced apart to define a desolvation and separation region, wherein said inlet electrode separates said desolvation and separation region from said ionization source, and communicates said ion source with said desolvation and desolvation region through an inlet slit, and wherein said outlet electrode separates said desolvation and separation region from said analyzer, and communicates said desolvation and separation region with said analyzer through an outlet slit;
a source of clean gas, which provides a continuous flow of sweep gas;
a heating stage for heating said continuous flow of sweep gas, to a temperature higher than the boiling point of said charged droplets;
a laminarizing stage, configured to minimize turbulence in said continuous flow of sweep gas;
a voltage source, which provides a voltage that creates an electric field between said inlet electrode and said outlet electrode, such that said ions are directed form said inlet slit towards said outlet slit; and
a sweep flow outlet,
wherein said continuous flow of sweep gas, after passing through said heating and laminarizing stages, is directed towards said sweep flow outlet, said continuous flow of sweep gas passing across said desolvation and separation region, such that any said charged droplets within the flow of ions are at least partially evaporated by said continuous flow of sweep gas and such that said charged droplets which cannot be completely evaporated, said low mobility charged particles, and said neutral species are swept by said continuous flow of sweep gas to said sweep flow outlet so as to limit entry thereof into said analyzer; and
wherein such electric field being configured so that ions resulting from said partially evaporated droplets are also directed towards the outlet slit.

2. The system of claim 1, wherein said analyzer is a mass spectrometer.

3. The system of claim 2, wherein said outlet slit is shaped as an elongated slit in the side of said outlet electrode that communicates with said desolvation and separation region, wherein said outlet slit is shaped as a rounded orifice in the side of said outlet electrode that communicates with said mass spectrometer, and wherein the geometry of said outlet slit transitions between said elongated shape and said rounded orifice along the width of said outlet electrode.

4. The system of claim 1, wherein said analyzer is an Ion Mobility Spectrometer (IMS).

5. The system of claim 4, wherein the inlet of said IMS is configured as an elongated slit, including:
a. differential mobility analyzer (DMA), and
b. Variable Electric Field Mobility Analyzer (VEFMA).

6. The system of claim 5, wherein said outlet electrode is configured to serve also as the inlet electrode of said DMA or said VEFMA, and wherein said outlet slit also serves as an inlet slit of said DMA or said VEFMA.

7. The system of claim 1, wherein said ion source is one of the type:
a. an electrospray (ESI) or
b. a Secondary Electro-Spray Ionization (SESI)
c. a Low Flow SESI.

8. The system of claim 7, wherein said ion source is a Low Flow SESI, wherein said inlet electrode is configured to serve also as the impaction plate of said Low Flow SESI, and wherein said inlet slit also serves as:
a. the impaction orifice of said Low Flow SESI, or
b. the impaction slit of said Low Flow SESI.

9. The system of claim 8, wherein said analyzer is an Ion Mobility Spectrometer (IMS) with the inlet of said IMS is configured as an elongated slit, including:
a. differential mobility analyzer (DMA), and
b. Variable Electric Field Mobility Analyzer (VEFMA).
and wherein said outlet electrode is configured to serve also as the inlet electrode of said DMA or said VEFMA, and wherein said outlet slit also serves as an inlet slit of said DMA or said VEFMA.

10. The system of claim 1, further comprising:
a. an axial electrode located between said outlet electrode and an inlet of said analyzer, said axial electrode incorporating an axial orifice or slit aligned with said outlet slit and said analyzer inlet
b. a second flow of clean and heated gas
c. a second voltage supply
wherein said second flow of gas is passed through said axial orifice or slit and it is directed towards said outlet slit, and wherein said second voltage supply provides a constant voltage that creates an electric field that pushes said ions passing through said outlet slit against said second flow of clean and heated gas, through said axial orifice or slit, and towards said analyzer inlet, such that ions are further dried in an environment free of said charged droplets which cannot be completely evaporated, said low mobility charged particles, and said neutral species.

11. The system of claim 1, further comprising a converging flow path located between said laminarizing stage and said desolvation and separation region, wherein said continuous flow of sweep gas is accelerated, such that laminarization occurs at lower velocities, and such that the pressure drop across said laminaraizing stage is reduced, and turbulence levels are also minimized.
